(19) United States
(12) Patent Application Publication
(10) Pub. No.: US 2020/0165047 A1
(43) Pub. Date: May 28, 2020

(54) BOTTOM GUSSET PACKAGE WITH FOLDED GUSSET

(71) Applicant: Innoflex Incorporated, Mobile, AL (US)

(72) Inventor: James W. Yeager, Mobile, AL (US)

(21) Appl. No.: 16/630,276

(22) PCT Filed: Jul. 11, 2018
(86) PCT No.: PCT/US18/41641

§ 371 Date: Jan. 10, 2020

Related U.S. Application Data
(60) Provisional application No. 62/531,158, filed on Jul. 11, 2017.

(51) Int. Cl. B65D 75/00; B65D 33/25; B65D 75/58; B31B 70/60; B31B 70/81; B31B 70/16

(52) U.S. Cl. CPC B65D 75/008; B65D 33/2508; B65D 75/5805; B31B 2160/20; B31B 70/813; B31B 70/16; B31B 70/60

(57) ABSTRACT

A bottom-gusseted package is disclosed which includes a bottom gusset positioned transversely of a longitudinal axis of the package, and a top sleeve portion including a recloseable fastener provided at the top of the package. In the illustrated embodiment, the top sleeve portion includes a peel seal positioned above the recloseable fastener. This seal desirably acts to close the two layers of the top sleeve portion at the top of the package for a neat and aesthetically pleasing appearance. The top sleeve portion can also include a frangible region, and at least one grip strip on the interior of the top sleeve portion. The configuration of the package, and its method of formation, permit use with associated form, fill, and seal equipment.

### CROSS-REFERENCE TO RELATED APPLICATIONS

This application claims priority of Provisional Ser. No. 62/531,158, filed Jul. 11, 2017, the disclosure of which is hereby incorporated by reference in its entirety.

### FEDERALLY SPONSORED RESEARCH OR DEVELOPMENT

Not Applicable.

### MICROFICHE/COPYRIGHT REFERENCE

Not Applicable.

### TECHNICAL FIELD

The present invention relates generally to packages formed from polymeric film webs, and more particularly to a bottom-gusseted package including a bottom gusset positioned transversely of a longitudinal axis of the package, and a recloseable fastener provided at the top of the package, with the configuration of the package, and its method of formation, permitting use with associated form, fill, and seal equipment.

### BACKGROUND OF THE INVENTION

Packages formed from plastic, polymeric film material have found widespread application in the market place for convenient and efficient packaging of all manner of food and non-food products. Packages of this nature typically are formed by folding and sealing a web of polymeric material to form a package body having front and rear package panels, with the package panels joined to each other at margins thereof. Depending upon the method of formation, the front and rear package panels may be joined to each other either by folded portions of the package body, or at seals (typically heat seals) joining the package panels to each other.

Non-gusseted packages of this type are sometimes referred to as “pillow packs”, and do not include either side gussets or top or bottom gussets. However, for many applications it is desirable to form a gusseted package that is, providing the package with inwardly-extended, pleat-like gussets at one or more margins of the package body. For example, side-gusseted packages include inwardly extending side gussets at opposite lateral sides of the package body, which side gussets join respect lateral edges of the front and rear package panels to each other.

For some applications, it is especially desirable to provide a bottom-gusseted package, that is, a package having an inwardly extending gusset at the bottom of the package body. By virtue of the breadth and stability provided by the bottom gusset, packages of this nature can frequently be configured to be self-standing, promoting efficient display for consumer selection.

U.S. Pat. No. 9,272,481, issued Mar. 1, 2016, which is hereby incorporated by reference, discloses a method of making bottom-gusseted packages by transversely positioning gusset-forming sleeves transversely of web of material from which packages are formed.

The present invention contemplates a bottom-gusseted package, and a method of formation, which, addresses the shortcomings in the conventional forming of bottom-gusseted package, and permits formation of a bottom-gusseted package having a recloseable fastener to facilitate convenient access to and closing of the contents of the package.

### SUMMARY OF THE INVENTION

A bottom-gusseted package embodying the principles of the present invention comprises a package body formed from a flexible web having a longitudinal axis, and includes a bottom-gusset which desirably permits the package to a have a self-standing configuration. Convenient opening and closing of the package is facilitated by the provision of a recloseable fastener generally at the top of the package.

For package formation, the flexible web which forms the body of each package is folded to define a front package panel and a rear package panel of the package body. The front and rear package panels are joined to each other at respective lateral side margins of the package body, with the flexible web being joined to itself along a seam which extends parallel to the longitudinal axis of the flexible web. Suitable polymeric material can be employed by virtue of its liquid-impermeable characteristics, and heat-sealing capabilities.

Notably, a package formed in accordance with the present invention includes a bottom gusset positioned between the front and rear package panels, with the bottom gusset extending upwardly and inwardly from the lower edges of the front and rear package panels. By formation of the present package in accordance with the present invention, the bottom gusset is positioned within the package body transversely of the longitudinal axis of the package body, and transversely of the longitudinal axis of the flexible web from which the package body is formed. As a consequence, a package body can be very efficiently formed at any selected height, without necessarily being limited by the width of the flexible web from which the package is formed.

Notably, the versatility of the method of package formation in accordance with the present invention permits formation of a bottom-gusseted package in different configurations. In an illustrated embodiment, a bottom-gusseted package is formed with a top sleeve portion that includes a recloseable fastener assembly at the upper portion of the package, with the top sleeve portion provided with a peel seal for sealing the package contents and to provide a tamper-evident feature. The top sleeve portion may further include a lock-up seal positioned above the respective recloseable fastener to provide the package with a neat and aesthetically pleasing appearance.

The present bottom-gusseted package can be formed by folding the flexible web of material generally at opposite margins thereof and joining the margins to form a back-seam package, with the seam positioned in the rear package panel. Alternatively, the flexible web of material can be folded at the longitudinal axis thereof, with the joined lateral margins of the flexible web providing a seam at one side edge of the package, and with the bottom gusset of the package thus extending generally between the longitudinal axis of the web of material and the package seam. In the illustrated embodiment, the bottom gusset of the package extends less than the width of the front and rear package panels.

The present method includes forming bottom-gusseted packages by the provision of a flexible, sleeve-forming recloseable fastener web. The sleeve-forming web is folded and generally tubular, and configured to include a series of recloseable fastener assemblies, a series of peel seals, and other features. The features can be provided in a substantially continuous form on the sleeve-forming web if desired. An inside surface of the folded, sleeve-forming web does not heat-seal to itself, thus facilitating formation of a bottom gusset which spreads or opens to permit the packages being formed to be generally self-standing. The specific composition of the materials from which the package body and bottom gusset are formed can be selected as appropriate for specific applications. For example, the sleeve-forming web, which forms the bottom gussets, can be made from a material which is different than the flexible web which forms the package body

The present method further comprises the step of cutting the flexible, sleeve-forming web into a plurality of individual sleeves, each having a folded, generally tubular configuration. The individual sleeves are next joined to the flexible web in spaced apart relationship longitudinally of the flexible web, transversely of the longitudinal axis of the flexible web. The spacing between individual sleeves corresponds to the length of each of the bottom-gusseted packages being formed. Notably, each individual sleeve eventually forms the bottom gusset of one package, and the top sleeve portion of an adjacent one of the packages being formed. Efficient formation is thus promoted.

After the individual sleeves are joined to the flexible web, the flexible web is folded and joined along lateral margins thereof to form a generally tubular, folded flexible web. The individual sleeves are positioned generally within the folded flexible web, in spaced apart relationship. Folding of the flexible web material forms a package body for each of the bottom-gusseted packages, with each package body including a front package panel and a rear package panel joined at opposite side margins thereof.

Next, the folded flexible web is cut at intervals each corresponding in length to the length of each of the bottom-gusseted packages being formed. By this cutting step individual packages are formed so that each individual sleeve provides a bottom gusset for each one of the packages. The cutting step includes cutting through each of the individual sleeves positioned within the folded flexible web so that a portion of each individual sleeve provides: (1) the bottom gusset for one of the packages being formed, and (2) the top sleeve portion for an adjacent one of said packages being formed.

In accordance with the present invention, each of the top sleeve portions is provided with a recloseable fastener positioned within the respective top sleeve portion. Each recloseable fastener comprises a pair of fastener elements respectively joined to confronting inside surfaces of each top sleeve portion. The fastener elements may comprises profile fastener elements, adhesive fastener components, hook-and-loop style fastener components, “unisex” self-engaging fastener components, and other releasable fastener arrangements as are known in the art. Additionally, each of the top sleeve portions is provided with a peel seal on the confronting inside surfaces of the top sleeve portion for sealing the interior of the package, and a lock-up seal for joining the two layers of material from which each top sleeve portion is formed.

The combination of the gusset-forming sleeve material and the associated recloseable fasteners, referred to hereinafter as a recloseable fastener web, is sometimes referred to as zipper tape, by virtue of the contemplated substantially continuous form of the recloseable fastener elements and gusset-forming material.

Package formation is preferably effected by configuring each of the individual sleeves to have a length which is less than the width of the folded web of flexible material. This facilitates formation of the bottom gusset with a width less than the width of the package, which desirably avoids the need to bend or otherwise deform the recloseable fastener elements, and permits formation of side seals between the front and read package panels of each package at opposite side edges of the bottom gusset of the package. Each of these side seals overlaps a respective end of the bottom gusset of the package and extends above the respective bottom gusset. Such side seals can be formed of a sufficient width to permit the package to be readily self-standing and stable.

In accordance with the illustrated embodiment, the present method includes forming each of the top sleeve portions with a lock-up seal positioned above the respective recloseable fastener. This seal desirable acts to close the two layers of the top sleeve portion at the top of the package for a neat and aesthetically pleasing appearance. This lock-up seal can be provided in the form of an adhesive which adheres and bonds to the interior surfaces of the gusset-forming sleeves, since these interior surfaces are selected so that they do not adhere to each other, i.e., the interior surface of each sleeve does not heat-seal to itself. In the illustrated embodiment, each of the top sleeve portions is formed with the lock-up seal positioned above the recloseable fastener, with the peel seal positioned intermediate the lock-up seal and the recloseable fastener.

The present method further contemplates the optional formation of a frangible region in each of the top sleeve portions to facilitate access to the contents of the package by removal of the upper portion of the package, including a portion of the top sleeve portion. Notably, by virtue of the provision of the peel seal in the top sleeve portion, the frangible region can be provided in the form of a plurality of perforations positioned intermediate the lock-up seal and the recloseable fastener. The peel seal acts to hermitically seal the interior of the package even if the perforations do not form such a seal.

In order to facilitate convenient manipulation and opening of the top sleeve portion of the package to gain access to the peel seal and the recloseable fastener, at least one grip strip can be provided on the interior of each of the top sleeve portions. The strips can be provided in the formed of raised or profiled ribs or the like to facilitate gripping and manipulation of the top sleeve portion of the package.

Thus, a recloseable package configured in accordance with the present comprises a package body formed from a flexible web having a longitudinal axis, with the flexible web being folded to define a front package panel and a rear package panel of said package body. The front and rear package panels are joined to each other at respective lateral side margins of the package body, with the flexible web being joined to itself along a seam which extends parallel to the longitudinal axis of the flexible web.

The present package further includes a bottom gusset positioned between the front and rear package panels, with the bottom gusset extending less than the width of the front and rear package panels. Laterally opposite side seals, that join the front and read package panels to each other at the respective lateral side margins of said package body, each overlap and extend above a respective end of the bottom gusset.

The present package further includes a top sleeve portion positioned between the front and rear package panels at an upper portion of the package, generally opposite the bottom gusset, with the top sleeve portion including a recloseable fastener positioned within the top sleeve portion. The recloseable fastener comprises a pair of fastener elements respectively joined to confronting inside surfaces of the top sleeve portion, with the top sleeve portion including a peel seal for sealing the interior of the package.

In the illustrated embodiment, the top sleeve portion includes a lock-up seal positioned above the recloseable fastener. The top sleeve portion can also include at least one grip strip on the interior of the top sleeve portion.

In the embodiment shown, the peel seal is positioned intermediate the lock-up seal and the recloseable fastener, with the top sleeve portion comprising a frangible region comprising a plurality of perforations positioned intermediate the lock-up seal and the recloseable fastener. Optionally, the front and rear package panels can include a weakened region aligned with the perforations provided in the top sleeve portion, which weakened region can comprise laser scoring.

The present invention further contemplates the formation of a recloseable fastener web, comprising a folded web of sleeve-forming material having an interior surface which does not heat-seal to itself, and a recloseable fastener assembly provided on the interior surface of folded web. The fastener web includes a peel seal and a lock-up seal formed on the folded web prior to cutting of the web into individual sleeves for formation of a bottom gusseted package in accordance with the present invention.

Other features and advantages of the present invention will become readily apparent from the following detailed description, the accompanying drawings, and the appended claims.

### BRIEF DESCRIPTION OF THE DRAWINGS

FIG. 1 is a diagrammatic perspective view of a bottom-gusseted package, configured as a recloseable package, embodying the principles of the present invention;

FIG. 2 is a diagrammatic perspective view similar to FIG. 1, with portions of the package cut away to illustrate the bottom gusset and recloseable fastener of the package;

FIG. 3 is a diagrammatic view illustrating formation of the package shown in FIGS. 1 and 2, in accordance with the present invention;

FIG. 4 is a diagrammatic cross-sectional view taken generally along lines 4-4 of FIG. 3;

FIG. 5 is a diagrammatic view further illustrating formation of a recloseable, bottom-gusseted package;

FIG. 6 is a cross-sectional view taken generally along lines 6-6 of FIG. 5; and

FIG. 7 is a diagrammatic view further illustrating formation of the present package, including cutting into individual packages.

### DETAILED DESCRIPTION OF THE PREFERRED EMBODIMENT

While the present invention is susceptible of embodiment in various forms, there is shown in the drawings and will hereinafter be described the presently preferred embodiments, with the understanding that the present disclosure should be considered as an exemplification of the invention, and is not intended to limit the invention to the specific embodiments illustrated.

A bottom-gusseted package embodying the principles of the present invention comprises a package body formed from a flexible web having a longitudinal axis, and includes a bottom-gusset which desirably permits the package to a have a self-standing configuration. Convenient opening and closing of the package is facilitated by the provision of a recloseable fastener generally at the top of the package. In the illustrated embodiment, the top sleeve portion includes a peel seal, and a lock-up seal positioned above the recloseable fastener. This seal desirable acts to close the two layers of the top sleeve portion at the top of the package for a neat and aesthetically pleasing appearance.

The top sleeve portion can also include at least one grip strip on the interior of the top sleeve portion. In accordance with the illustrated embodiment, the present method includes forming each of said top sleeve portions with the lock-up seal positioned above the respective recloseable fastener.

The combination of the gusset-forming sleeve material and the associated recloseable fasteners is sometimes referred to a zipper tape, by virtue of the contemplated substantially continuous form of the recloseable fastener elements and gusset-forming material.

For package formation, the flexible web which forms the body of each package is folded to define a front package panel and a rear package panel of the package body. The front and rear package panels are joined to each other at respective lateral side margins of the package body, with the flexible web being joined to itself along a seam which extends parallel to the longitudinal axis of the flexible web. Suitable polymeric material can be employed by virtue of its liquid-impermeable characteristics, and heat-sealing capabilities.

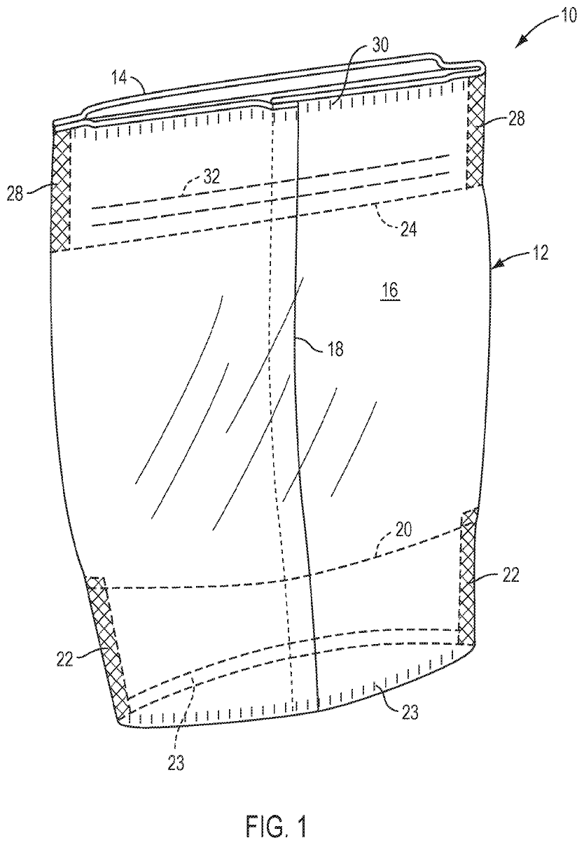

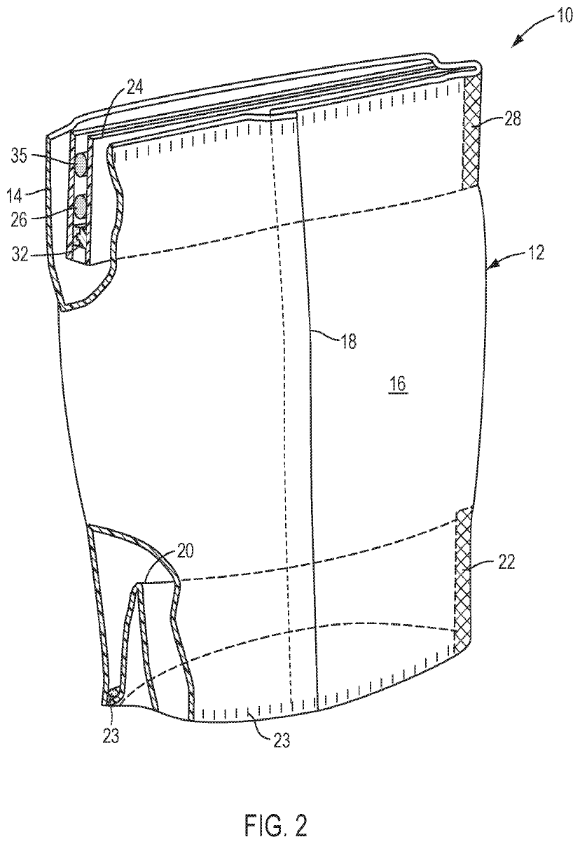

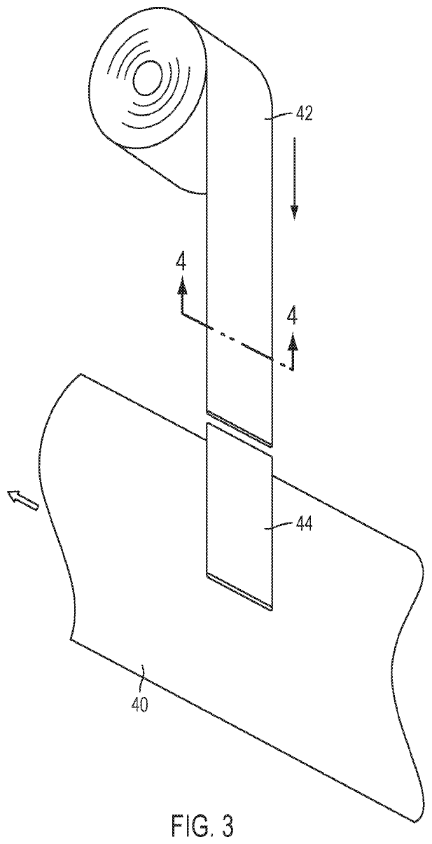

With reference first to FIGS. 1 and 2, therein is illustrated a bottom-gusseted package 10 embodying the principles of the present invention. As will be further described, bottom-gusseted package 10 is configured as a recloseable package, and includes a recloseable fastener at an upper portion of the package. Notably, and as will be further described, package 10 is formed by joining a plurality of individual sleeves to an associated web of flexible material, in spaced apart relationship along the longitudinal axis of the flexible web. Attendant to package formation, each individual sleeve is cut as individual packages are formed, with each individual sleeve providing a bottom gusset in one package, and a top sleeve portion, including a recloseable fastener, and other package features, in an adjacent one of the packages being formed.

With further reference to FIGS. 1 and 2, the bottom-gusseted package 10 illustrated therein includes a package body 12 formed from a flexible film web having a longitudinal axis, wherein the flexible web has been folded to define a front package panel 14 (shown facing rearwardly in FIGS. 1 and 2) and a rear package panel 16 of the package body 12. The front and rear package panels 14 and 16 are joined to each other at respective lateral side margins of the package body 12. In the illustrated embodiment, the front and rear package panels are joined to each other where the flexible film web from which the body is formed has been folded. The flexible film web from which the package body 12 is formed is joined to itself along a longitudinal seam 18 which extends parallel to the longitudinal axis of the flexible web. While seam 18 has been illustrated generally at the middle of rear package panel 16, the flexible web can otherwise be joined to itself, such as at along one of the lateral side margins of the package body.

By formation of the present package in accordance with the present invention, the bottom gusset is positioned within the package body transversely of the longitudinal axis of the package body, and transversely of the longitudinal axis of the flexible web from which the package body is formed. As a consequence, a package body can be very efficiently formed at any selected height, without necessarily being limited by the width of the flexible web from which the package is formed.

Efficient package formation is promoted by configuring each of the individual sleeves to have a length which is less than the width of the folded web of flexible material. This facilitates formation of the bottom gusset with a width less than the width of the package, which desirably avoids the need to bend or otherwise deform the recloseable fastener elements, and permits formation of side seals between the front and read package panels of each package at opposite side edges of the bottom gusset of the package. Each of these side seals overlaps a respective end of the bottom gusset of the package. Such side seals can be formed of a sufficient width to permit the package to be readily self-standing and stable.

In accordance with the present invention, package 10 includes a bottom gusset 20 which is positioned between the front and rear package panels 14 and 16, and which extends upwardly and inwardly from lower edges of the front and rear package panels. As will be further described, the pleat-like bottom gusset 20 is formed from a sleeve of material which is positioned within the flexible web from which the package body is formed, with the sleeve of material cut attendant to formation of individual packages.

In an illustrated embodiment, a bottom-gusseted package is formed which includes a recloseable fastener assembly 32 at the upper portion of the package, with the package provided with a peel seal 26, a lock-up seal 35, and additional features for sealing the package contents and to provide a tamper-evident feature, and to facilitate opening and reclosing of the package. In the illustrated embodiment, each of the top sleeve portions is formed with lock-up seal 35 positioned above the recloseable fastener 32, with the peel seal 26 positioned intermediate the lock-up seal 35 and the recloseable fastener 32.

The bottom gusset 20 is joined to and integrated with the package body by a pair of side seals 22 at opposite lateral margins of the package body, and a pair of end seals 23 which respectively join the edges of the bottom gusset 20 to the front and rear package panels 14 and 16. It is presently contemplated that the bottom gusset 20 be configured to have a width less than that of the package 10, which permits the formation of side seals to join the front and rear package panels to each other. This permits the formation of a stable and self-standing package, by closing the opposite ends of the bottom gusset. This can be desirable since the inwardly facing surfaces of the bottom gusset do not heat-seal to each other.

In accordance with this illustrated embodiment, the bottom-gusseted package 10 is configured for recloseable use. To this end, the package 10 includes a top sleeve portion 24 positioned between the front and rear package panels 14 and 16, at the upper end of the package body 12. The top sleeve portion 24 preferably includes a seal 26, which may be configured as a so-called “peel seal”, or otherwise configured for separation attendant to initial opening of the package. The top sleeve portion 24 can be otherwise configured to permit access to the contents of the package through the top sleeve portion, such as by the provision of a preferentially weakened region, as described below. The top sleeve portion 24 is joined to and integrated with the package body 12 by side seals 28 joining respective opposite ends of the sleeve portion 24 to the package body generally at opposite, lateral side margins thereof. A pair of top seals 30, respectively join the pair of legs or flanges of the top sleeve portion 24 to the front and rear package panels 14, 16.

In the illustrated embodiment, the top sleeve portion 24 includes the recloseable fastener 32. The recloseable fastener includes first and second fastener elements configured for releasable securement to each other, with the fastener elements respectively joined to the legs or flanges of the top sleeve portion 24. Thus, the sleeve portion 24 provides first and second mounting flanges for the first and second fastener elements, with the flanges respectively positioned inwardly of and joined to the front and rear package panels.

Recloseable fastener 32 preferably comprises a pair of interlocking profile fastener elements. Such fastener elements may be identically configured, or complementary. Adhesive fastener components, hook-and-loop fastener components, “unisex” self-engaging fastener components, or like recloseable fastening arrangements can be employed for the recloseable fastener 32. In accordance with the present invention, each of the top sleeve portions is provided with a recloseable fastener positioned within the respective top sleeve portion. Each recloseable fastener thus comprises a pair of fastener elements respectively joined to confronting inside surfaces of each top sleeve portion.

As will be appreciated, access to the contents of the package 10 is provided via the top sleeve portion 24 and recloseable fastener 32. For opening, the legs or flanges of the top sleeve portion 24 are separated, and the first and second fastener elements of the recloseable fastener 32 separated. For initial opening of the package, the peel seal 26 is opened and separated, with access to the interior of the package 10 thus provided. By merely pressing the sleeve portion 24 together, and urging the components of the recloseable fastener 32 together, the package 10 can be easily reclosed.

The present method further contemplates the optional formation of a frangible region in each of the top sleeve portion 24 to facilitate access to the contents of the package by removal of the upper portion of the package, including a portion of the top sleeve portion. Notably, by virtue of the provision of the peel seal 26 in the top sleeve portion, the frangible region can be provided in the form of a plurality of perforations 33 positioned intermediate the lock-up seal 35 and the recloseable fastener 32. The peel seal 26 acts to hermitically seal the interior of the package even if the perforations 35 do not form such a seal. As will be appreciated, if a recloseable fastener 32 is provided in the form of cooperating adhesive components, peel seal 26 may not be required.

In order to facilitate convenient manipulation and opening of the top sleeve portion of the package to gain access to the peel seal 26 and the recloseable fastener 32, at least one grip strip 37 (two being illustrated) can be provided on the interior of each of the top sleeve portions. The strips 37 can be provided in the formed of raised or profiled ribs or the like to facilitate gripping and manipulation of the top sleeve portion of the package.

In the embodiment shown, the peel seal 26 is positioned intermediate the lock-up seal 35 and the recloseable fastener 32, with the top sleeve portion 24 comprising a frangible region comprising a plurality of perforations 33 positioned intermediate the lock-up seal and the recloseable fastener. Optionally, the front and rear package panels can include a weakened region aligned with the perforations provided in the top sleeve portion, which weakened region can comprise laser scoring 39 (see FIG. 6). Laser scoring allows for a hermetically sealed package.

For package formation, a flexible web 40 preferably comprising heat-sealable polymeric material is provided, with flexible web 40 typically advanced in a direction along its longitudinal axis. Formation of the present bottom-gusseted package is further effected by providing a flexible, sleeve-forming recloseable fastener web 42, also preferably comprising suitable polymeric, heat-sealable material. The composition of the sleeve-forming web can differ from the flexible web 40 for forming the package of the body, as may be desired.

It is presently contemplated that only one side of the sleeve-forming web be heat-sealable, so that the inside surface of the folded, sleeve-forming web does not heat seal to itself. This permits the eventual opening and spreading of the legs of the bottom gusset 20 so that the package 10 can assume a generally self-standing orientation.

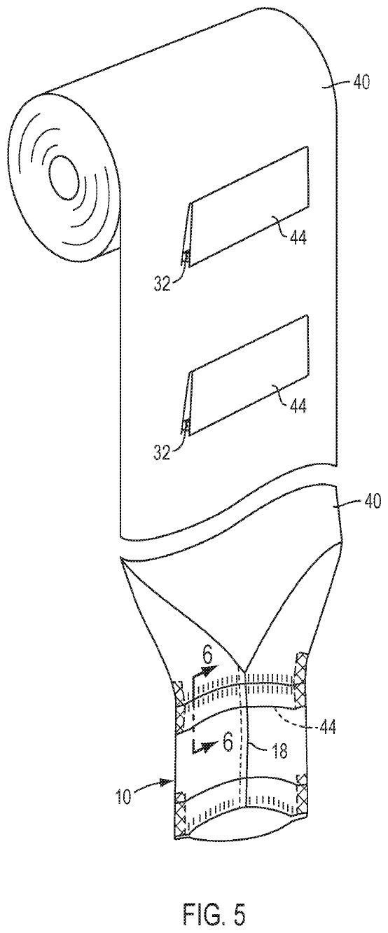

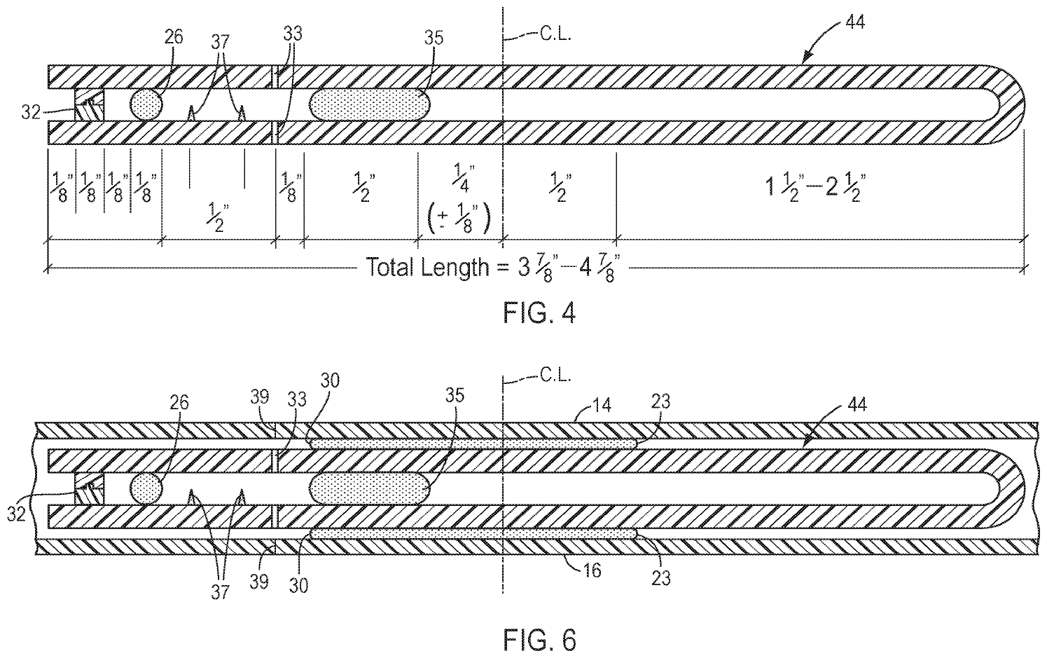

As shown on FIG. 4, the sleeve-forming web 42 may be provided with a tubular configuration, including the peel seal 26 releasably joining the legs or flanges of the sleeve-forming web. The sleeve-forming web is provided with recloseable fasteners 32, which may be provided in either continuous form, or as segmented, pre-cut lengths. As illustrated, the recloseable fastener elements are positioned generally within the sleeve-forming web 42, preferably in interconnected relationship.

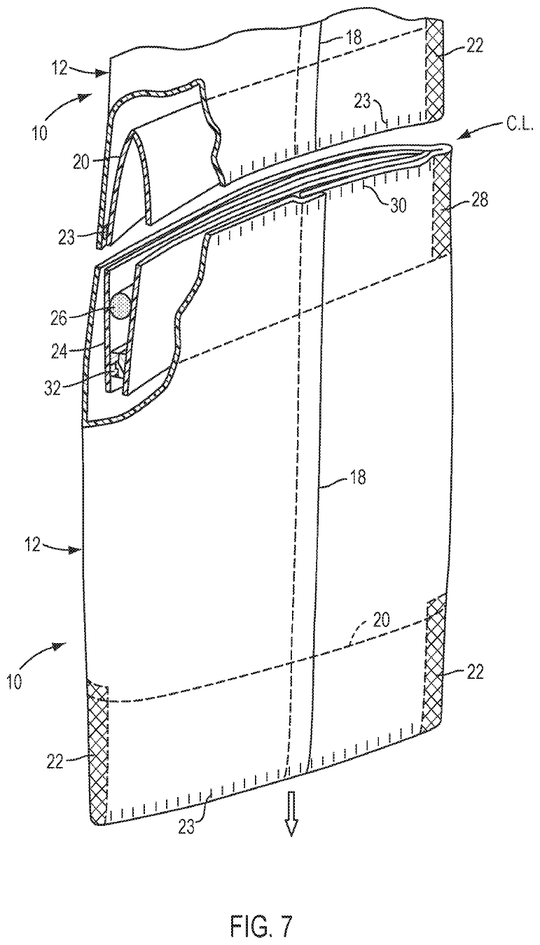

Notably, the present invention contemplates that each individual sleeve 44 spans and extends between two adjacent ones of the packages being formed, with subsequent cutting of the flexible web into individual packages resulting in each individual sleeve 44 providing a bottom gusset 20 for one package, and a top sleeve portion 24 for an adjacent one of the packages. FIGS. 5 and 6 illustrate the manner in which each individual sleeve 44 extends between adjacent ones of the packages, with FIG. 7 illustrating cutting of the folded flexible web 40 transversely of its longitudinal axis to form individual packages, including cutting through each sleeve portion 44 at cut line C.L. to form a bottom gusset 20 for one package, and a top sleeve portion 24 for an adjacent package (note that for clarity, lock-up seal 35 is not illustrated in FIG. 7) It is presently contemplated that formation in this manner can be effected, if desired, during packaging on a form, fill, and seal machine, or that individual packages can be formed for subsequent filling. Depending upon the specific formation technique, side seals 22 and 28 are typically formed prior to filling, with one of end seals 23, 30 formed after the contents of each package have been positioned therein.

The individual sleeves 44 are cut from the sleeve-forming web 42, and are positioned transversely of the longitudinal axis of the flexible web 40 from which the package body is formed. For some applications, it can be desirable to seal the ends of each individual sleeve 44, such as with suitable adhesive. The individual sleeves 44 are joined to the flexible web 40 in spaced apart relationship longitudinally of the web 40. The spacing between the individual sleeves 44 corresponds to the length of each of the bottom-gusseted packages 10 being formed. The ends of each sleeve 44 can be joined, such as by heat-sealing, to the web 40, by suitable end seals. Transverse seals can also be formed between the web 40 and the sleeve 44 extending generally parallel to fastener 32 along opposite side margins thereof.

After each of the individual sleeves 44 is joined to the flexible web 40, the flexible web is folded and the lateral margins thereof joined together to form a folded flexible web (see FIGS. 5 and 6). In this way, a package body is formed for each of the bottom-gusseted packages. By folding of the flexible web 40, the front and rear package panels 14 and 16 of each package are formed. The folded flexible web 40 can be joined to itself so as to form bag seam 18, with the front and rear package panels joined to each other at the folded, lateral margins of the folded web.

As illustrated, the individual sleeves 44 are positioned within the folded flexible web 40. After the individual sleeves are joined to the flexible web, the flexible web is folded and joined along lateral margins thereof to form a generally tubular, folded flexible web. The individual sleeves are positioned generally within the folded flexible web, in spaced apart relationship. Folding of the flexible web material forms a package body for each of the bottom-gusseted packages, with each package body including a front package panel 14 and a rear package panel joined at opposite side margins thereof. Next, the folded flexible web is cut at intervals each corresponding in length to the length of each of the bottom-gusseted packages being formed. By this cutting step individual packages are formed so that each individual sleeve provides a bottom gusset for each one of the packages. The cutting step includes cutting through each of the individual sleeves positioned within the folded flexible web so that a portion of each individual sleeve provides: (1) the bottom gusset for one of the packages being formed, and (2) a top sleeve portion for an adjacent one of said packages being formed.

From the foregoing, it will be appreciated that efficient formation of the present package can be effected by providing the sleeve-forming web 42, from which bottom gusset 20 and top sleeve portion 24 are formed, in the form a recloseable fastener web having fastener elements and seal elements provided thereon before the web is cut into individual sleeves 44. Various techniques can be employed for formation of such a recloseable fastener web, bearing in mind that the interior surface of the folded web does not heat-seal to itself, at the typical package-formation temperatures, so that the resultant bottom gusset of the package opens as intended. In this regard, materials exhibiting differing heat-sealing characteristics can be employed, so that seals such as peel seal 26 and lock-up seal 35 can be provided in the interior of the folded web without other portions of the web being adhered together. Lamination and/or co-extrusion formation techniques can be employed to obtain the desired arrangement.

The resultant recloseable fastener web, sometimes referred to a zipper tape, thus comprises a folded web of sleeve-forming material having an interior surface which does not heat-seal to itself, and a recloseable fastener assembly provided on the interior surface of the folded web. The fastener assembly comprises a pair of cooperating fastener elements respectively joined to confronting inside surfaces. The fasten elements may comprise profile elements co-extruded with the web, or may comprise adhesive elements applied to the web.

The recloseable fastener web further comprises a peel seal for sealing the interior of the package, and a lock-up seal positioned above the recloseable fastener assembly. These seals may be provided in the form of suitable adhesive applied to the web, and can be formed by co-extrusion. The peel seal can be positioned intermediate the lock-up seal and recloseable fastener assembly. If desired, the fastener sleeve can include a frangible region, which can comprise a plurality of perforations positioned intermediate the lock-up seal and the recloseable fastener.

From the foregoing, it will be observed that numerous modifications and variations can be effected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A method of making bottom-gusseted packages, comprising the steps of:
providing a flexible web of material having a longitudinal axis,
providing a flexible, sleeve-forming web;
cutting said flexible, sleeve-forming web into a plurality of individual sleeves;
joining said individual sleeves to said flexible web in spaced apart relationship longitudinally of said flexible web, with the spacing between said individual sleeves corresponding to the length of each of said bottom-gusseted packages being formed;
folding said flexible web of material and joining the lateral margins thereof to form a folded flexible web, and to thereby form a package body for each of said bottom-gusseted packages, each package body including a front package panel and a rear package panel joined at opposite side margins thereof, said individual sleeves being positioned generally within said folded flexible web;
cutting said folded flexible web at intervals each corresponding in length to said length of each of Said bottom-gusseted packages so each individual sleeve provides a bottom gusset for one of the packages being formed, wherein said cutting step includes cutting through each of said individual sleeves so that a portion of each individual sleeve provides: (1) said bottom gusset for one of the packages being formed, and (2) a top sleeve portion for an adjacent one of said packages being formed; and
providing each of said top sleeve portions with a recloseable fastener positioned within the respective top sleeve portion, each said recloseable fastener comprising a pair of fastener elements respectively joined to confronting inside surfaces of each top sleeve portion, and providing each of said top sleeve portions with a peel seal for sealing the interior of the package, and a lock-up seal positioned above said recloseable fastener.

2. A method of making bottom-gusseted packages in accordance with claim 1, including forming a frangible region in each of said top sleeve portions comprising a plurality of perforations positioned intermediate said lock-up seal and said recloseable fastener.

3. A method of making bottom-gusseted packages in accordance with claim 1, including forming said peel seal intermediate said lock-up seal and said recloseable fastener.

4. A method of making bottom-gusseted packages in accordance with claim 1, including providing at least one grip strip on the interior of each of said top sleeve portions.

5. A bottom-gusseted package, comprising:
a package body formed from a flexible web having a longitudinal axis, said flexible web being folded to define a front package panel and a rear package panel of said package body, said front and rear package panels being joined to each other at respective lateral side margins of said package body, said flexible web being joined to itself along a seam which extends parallel to said longitudinal axis of said flexible web;
a bottom gusset positioned between said front and rear package panels, and extending upwardly and inwardly from lower edges of said front and rear package panels, said bottom gusset extending less than the width of said front and rear package panels; and
a top sleeve portion positioned between said front and rear package panels at an upper portion of said package, generally opposite said bottom gusset, said top sleeve portion including a recloseable fastener positioned within the top sleeve portion, said recloseable fastener comprising a pair of fastener elements respectively joined to confronting inside surfaces of said top sleeve portion, said top sleeve portion including a peel seal for sealing the interior of the package, and a lock-up seal positioned above said recloseable fastener.

6. A bottom-gusseted package in accordance with claim 5, wherein said top sleeve portion includes at least one grip strip on the interior of the top sleeve portion.

7. A bottom-gusseted package in accordance with claim 6, wherein said peel seal is positioned intermediate said lock-up seal and said recloseable fastener.

8. A bottom-gusseted package in accordance with claim 7, wherein said top sleeve portion comprises a frangible region comprising a plurality of perforations positioned intermediate said lock-up seal and said recloseable fastener.

9. A bottom-gusseted package in accordance with claim 8, including a weakened region in said front and rear package panels aligned with said plurality of perforations.

10. A bottom-gusseted package in accordance with claim 9, wherein said weakened region in said front and rear package panels comprises laser scoring.

11. A bottom-gusseted package in accordance with claim 10, wherein laterally opposite side seals that join the front and read package panels to each other at the respective lateral side margins of said package body, each of said side seals overlapping a respective end of said bottom gusset.

12. A bottom-gusseted package, comprising:
a package body formed from a flexible web having a longitudinal axis, said flexible web being folded to define a front package panel and a rear package panel of said package body, said front and rear package panels being joined to each other at respective lateral side margins of said package body, said flexible web being joined to itself along a seam which extends parallel to said longitudinal axis of said flexible web;
a bottom gusset positioned between said front and rear package panels, and extending upwardly and inwardly from lower edges of said front and rear package panels, said bottom gusset extending less than the width of said front and rear package panels; and
a top sleeve portion positioned between said front and rear package panels at an upper portion of said package, generally opposite said bottom gusset,
said top sleeve portion including a recloseable fastener positioned within the top sleeve portion, said recloseable fastener comprising a pair of fastener elements respectively joined to confronting inside surfaces of said top sleeve portion,
said top sleeve portion further including a peel seal for sealing the interior of the package, and a lock-up seal positioned above said recloseable fastener, wherein said peel seal is positioned intermediate said lock-up seal and said recloseable fastener,
said top sleeve portion comprising a frangible region comprising a plurality of perforations positioned intermediate said lock-up seal and said recloseable fastener, said package body including a weakened region in said front and rear package panels aligned with said plurality of perforations.

13. A bottom-gusseted package in accordance with claim 12, wherein weakened region in said front and rear package panels comprises laser scoring.

14. A bottom-gusseted package in accordance with claim 13, wherein said top sleeve portion includes at least one grip strip on the interior of the top sleeve portion.

15. A recloseable fastener web, comprising:
a folded web of sleeve-forming material having an interior surface which does not heat-seal to itself;
a recloseable fastener assembly provided on the interior surface of said folded web, comprising cooperating a pair of fastener elements respectively joined to confronting inside surfaces of said top sleeve portion,
a peel seal for sealing the interior of the package, and
a lock-up seal positioned above said recloseable fastener.

16. A recloseable fastener web in accordance with claim 15, wherein
said peel seal is positioned intermediate said lock-up seal and said recloseable fastener assembly,

17. A recloseable fastener web in accordance with claim 15, wherein
said folded web comprises a frangible region comprising a plurality of perforations positioned intermediate said lock-up seal and said recloseable fastener.

18. A recloseable fastener web in accordance with claim 15, wherein
said recloseable fastener assembly comprises profile fastener elements.
